(19) United States
(12) Patent Application Publication
(10) Pub. No.: US 2012/0001419 A1
(43) Pub. Date: Jan. 5, 2012

(54) Connection Arrangement For Connecting Two Components

(76) Inventor: Klaus Wohlfarth, Fichtenberg (DE)

(21) Appl. No.: 13/171,666

(22) Filed: Jun. 29, 2011

(30) Foreign Application Priority Data
Jun. 30, 2010 (DE) 10 2010 030 754.8

(51) Int. Cl. F16L 15/04; F16L 15/08; F16L 15/00

(52) U.S. Cl. 285/330; 285/390; 285/355

(57) ABSTRACT

A connection arrangement for connecting two especially cylindrical oil-containing components contains two receiving rings, each having a hollow connecting piece attached radially to the outside of the receiving ring with a passageway that ends at the inside of the receiving ring. The outer end section of the passageway contains a thread, wherein the pitch of the threads of the two connecting pieces is different. The two connecting pieces are connected by a hollow screw having two threaded sections. The thread of one threaded section corresponds to the thread of one connecting piece, and the thread of the other threaded section corresponds to the thread of the other connecting piece. The receiving rings are connected to the components such that a fluid connection is provided between the inner chambers of the two components through the two connecting pieces.

The invention relates to a connection arrangement for connecting two components that contain oil and are to exchange oil. The connection arrangement establishes both a mechanical connection between the two components as well as a hydraulic connection.

An example of such an arrangement is the connection between a shock absorber housing and an equalizing chamber in a motor vehicle. The shock absorber housing is cylindrical, and the equalizing chambers can also be the cylindrical. They are normally located next to the shock absorber's housing. A problem is that there can be insufficient space next to the shock absorber housing to accommodate a shock equalizing chamber of a certain length. Such problems can however also arise with other applications.

The object of the invention is to create a way to connect two oil-containing components in which the geometric arrangement of the two components can be easily modified without changing the components themselves, especially for reasons of space.

To achieve this objective, the invention proposes a connection arrangement with the features cited in claim 1. The developments of the invention are the subject matter of subclaims.

According to the invention, a hollow connecting piece is provided for each of the two components that is either directly connected to the component or can be affixed to it. The passageway of the connecting piece leads to the chamber that contains the oil. The end of the connecting piece lies in an at least approximately flat end face. The two end faces are coordinated with each other such that the two connecting pieces can be joined. When the two connecting pieces are joined, the two passageways of the connecting pieces lie within a mutual extension to allow oil to be exchanged through the connecting pieces. A hollow screw serves to mechanically connect the two connecting pieces and engages with one thread in the thread of one connecting piece and with the other thread in the thread of the other connecting piece. Since the pitches of the two threads differ, the two connecting pieces press against each other when the hollow screw is screwed tight. The two connecting pieces interact with the screw like a nut and locknut so that additional measures are not necessary to secure the screwed connection.

In a development of the invention, the two end faces can be flat so that their surfaces can lie directly on each other.

To ensure that the set angular position is retained even under unfavorable conditions, a development of the invention can provide that the connection arrangement comprises a device for locking the two connecting pieces against rotating about the axis formed by the screw; this should be an interlocking lock. This interlocking twist lock can, for example, be formed by both end faces having projections and recesses that match each other. These could be radial ribs and grooves.

In particular, the invention proposes that the device for locking against rotation has blind holes in the end face of each connecting piece, and at least one alignment pin is provided that can be inserted in a tight-fitting blind hole and, after assembly, engages in two opposing blind holes. Of course, a plurality of alignment pins can also be used.

To design a seal as simply as possible, a development according to the invention can provide that one end face of the two connecting pieces has a groove running around the inner opening of the connecting piece in which an O-ring can be inserted as a seal. This can in particular interact with a flat end face of the other connecting piece in this area.

It was mentioned at the onset that each connecting piece leads into an oil-containing chamber of the associated component. The connecting piece can, for example, be attached directly to the housing of the associated component, especially welded on.

It is, however, also possible and proposed by the invention for a connecting piece to be attached, for example welded on, to a seat element that is then connected to the component. This seat element such as a receiving ring is of course connected such that this connection is liquid tight.

For example, the inside of a receiving ring facing the component can have a recess connecting with the connecting piece attached to it, for example a groove and especially a peripheral groove, and the smooth, cylindrical surface surrounding the recess corresponds to the outer surface of the component. This receiving ring can then be connected to the component such that an opening in the housing of the component ends in the recess in the receiving ring.

If the recess is a peripheral groove, a smooth, cylindrical surface is formed to either side of the peripheral groove that serves to guide the receiving ring along the associated component. When the basic shape of the receiving ring and component is a circular cylinder, the receiving ring and hence the connecting piece can be arranged in any angular position with reference to the axis of the cylindrical component. This further increases the ways in which the second component can be arranged without changing it.

Another development of the invention can provide that the housing of the component to which the receiving ring is connected has a plurality of radial openings distributed over the perimeter and not just one. This makes the flow of oil more uniform and increases the cross-section even though the holes are relatively small.

A development according to the invention can provide that the component to which the receiving ring is attached has a peripheral groove for receiving a seal opposite the smooth surface of the receiving ring to either side of the location where the radial openings end. The arrangement of the seals in the outside of the component makes it easier to install the seals than if they were in the inside of the receiving ring.

In particular, a hexagon socket can be provided as a drive to turn the hollow screw by means of which the two connecting pieces are pressed against each other.

It was already noted at the onset that one application is connecting an equalizing chamber to a shock absorber housing. In this case, the first component is, for example, the shock absorber housing, and the second component is the equalizing chamber.

Additional features, details and preferences of the invention are found in the claims and abstract, the wording of both has been made the content of the description by means of reference, the following description of preferred embodiments of the invention, and the drawing. They show:

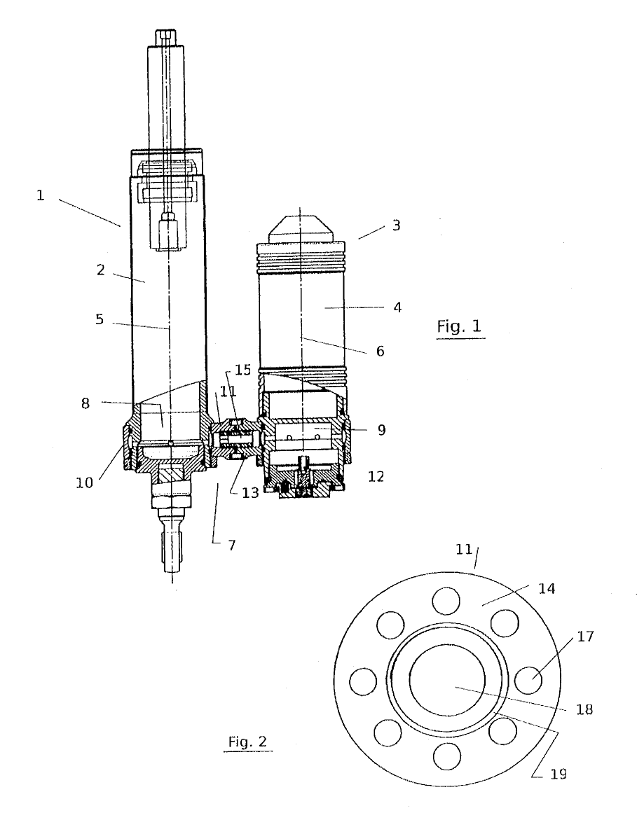

FIG. 1 In a partially cutaway side view, the connection of an equalizing chamber to a shock absorber housing;

FIG. 2 Schematic view of an end face of a connecting piece;

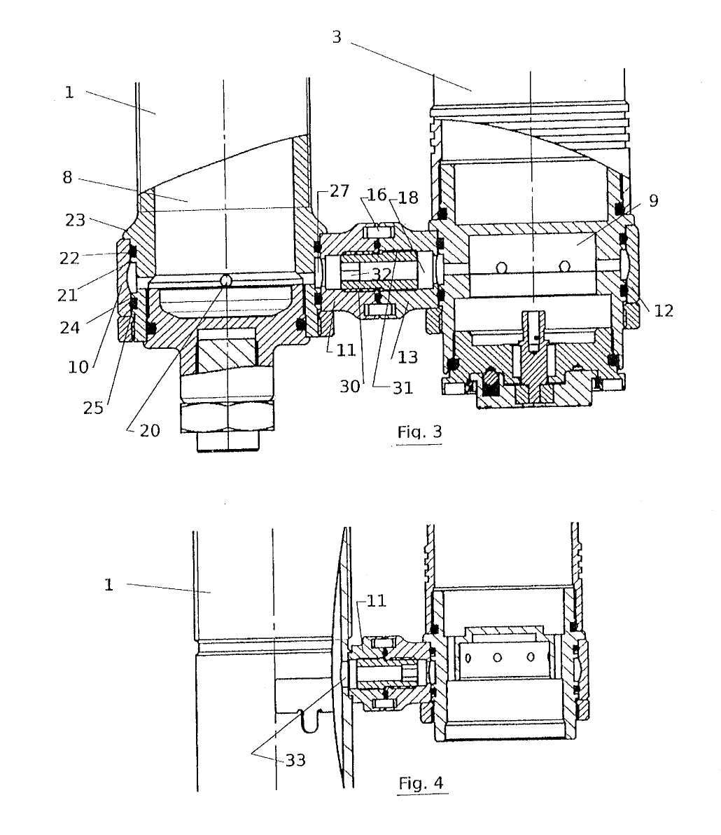

FIG. 3 Section from the arrangement in FIG. 1 on an enlarged scale;

FIG. 4 A representation of a modified embodiment corresponding to FIG. 3.

FIG. 1 shows a first component 1 in the form of a shock absorber housing 2 in a partially cutaway side view. A second component 3 arranged parallel to the cylindrical component 1 is an equalizing chamber 4 for the shock absorber 2. Both cylindrical components 1, 3 run parallel to each other, which is portrayed by the indicated central axes 5, 6. In a view from the right in FIG. 1, the two components 1, 3 also run parallel to each other in the portrayed position.

The shock absorber 2 portrayed in a simplified manner contains an inner chamber 8 that is filled with oil. The equalization chamber 4 also contains an inner chamber 9 that is filled with oil. Between the two chambers 8, 9 filled with oil, a mechanical and hydraulic connection is created through a connection arrangement.

A connection arrangement 7 serves to connect the two components 1, 3 to each other. The connection arrangement 7 contains a first receiving ring 10 that is connected to the shock absorber 2. On the side, a hollow connecting piece 11 is connected, for example welded, to the receiving ring 10. The connection arrangement contains a second receiving ring 12 with a similar structure that is attached to the equalizing chamber 4. This receiving ring also has a hollow connecting piece 13 on the side. The two connecting pieces 11, 13 each have an end face with which they abut each other. To connect the two connecting pieces 11, 13 to or with each other, a hollow screw 15 engages in each of the connecting pieces 11, 13 by means of a thread. To prevent rotation about the axis formed by the screw 15, alignment pins 16 are provided that engage in opposing blind holes 17 that proceed from the end face 14 of each connecting piece 11, 13.

This arrangement of the blind holes 17 in the end face 14 of a connecting piece 11 is shown in FIG. 2. FIG. 2 shows a view of such a connecting piece from its free end face 14. An inner opening 18 is provided in the connecting piece that axially traverses the connecting piece. Each connecting piece 18 has an inner thread at least in the area proceeding to the end face 14. An inner groove 19 is formed in the end face 14 around the inner opening 18 of one of the two connecting pieces, and it serves to receive a seal. The aforementioned blind holes 17 are arranged outside of the seals in the end face 14, and their angular distance is 45° in the simplified representation in FIG. 2, wherein the number and arrangement of blind holes depends on the scope of adjustment. With the exception of the peripheral groove 19, the end faces of the two connecting pieces 11, 13 have a mirror image design. By inserting alignment pins 16 in the corresponding blind holes 17, a specific angular position can be set about the axis formed by the screw 15.

Details of the arrangement are easier to perceive in the enlarged representation in FIG. 3. From the holding chamber 8 of the first component 1, a plurality of radial holes 20 proceed from the inside to the outside of the component 1. A peripheral rib 21 with a groove to receive a seal 22 is formed on the outside of the component 1 axial to both sides of the site where the radial holes 20 end. Above the rib 21 with the seal 22 on the top side of the holes 20 in FIG. 1, a shoulder 23 is formed that faces downward. The receiving ring 10 is pushed from below onto the shock absorber housing 2 until its top edge abuts the shoulder 23. In this position, the smooth, cylindrical inner surface of the receiving ring 10 lies on the radial outer side of rib 21 such that the seal 22 interacts with the smooth inner surface.

Such a rib 24 is also formed with a groove and a seal 25 below the site where the holes end 20. The receiving ring 10 also abuts at this site to provide a seal. This arrangement is secured in an axial direction by screwing on a nut 26. In this manner, the holes 20 end in a peripheral channel 27 between the two ribs 21, 24. The oil can pass from this channel 27 through the passageway 18 of the connecting piece 11 into the passageway 18 of the other connecting piece 13. By means of a similar arrangement, this other connecting piece 13 is connected to the inner chamber 9 of the second component 3.

As mentioned above, two connecting pieces 11, 13 have a thread 30, 31 in the region of their respective ends, and the thread 30 of one connecting piece 11 has a greater pitch than the thread 31 of the other connecting piece 13. The screw 15 also has two threads that engage with the threads 30, 31 of the two connecting pieces 11, 13. By screwing in the screw 15, the two connecting pieces 11, 13 are pressed together into the position defined by the alignment pins 16, and by turning the screw in the opposite direction they are released from each other.

To fix the rotary position of the two connecting pieces 11, 13 in relation to each other and hence the rotary position of the two axes 5, 6, the two receiving rings 10, 12 are arranged in the desired alignment before being attached to the components 1, 3, the alignment pins are inserted in the opposite blind holes 17, and the screw is tightened. A formed drive 32 in the form of a hexagon can be accessed from the inside of the receiving ring 10.

In the embodiment portrayed in FIGS. 1-3, the connection arrangement 7 contains two receiving rings, each having one connecting piece 11, 13. Both receiving rings can, for example, also be identical. It is also conceivable to attach a connecting piece 11 directly to a component. Such an option is portrayed in FIG. 4. In this instance, the left connecting piece 11 is attached, for example welded, directly to the housing of the component 1. Instead of the passageway 18 of the connecting piece 11, the wall of component 1 has an opening 33 through which the oil can be exchanged.

The advantage of the arrangement of the connecting piece with a receiving ring 10 or 12 is that the connecting piece can be oriented at any location in a peripheral direction opposite the housing since the oil can enter the channel 27 through the plurality of holes 20 and vice versa. If such variety is not desired, it is sufficient for there to be only one connection between the inner chamber 8 of one component and the passageway 18 of the connecting piece at only one location in a receiving ring.

In the embodiment shown in FIG. 3, the receiving ring 10, 12 also contains a flat groove that neighbors the channel 27. With the type of channel between two ribs 21, 24, the receiving ring 10, 12 could be designed to be completely cylindrical on the inside.

1. Connection arrangement for the mechanical and hydraulic connection of two oil-containing components (1, 3), comprising
a hollow connecting piece attached or attachable to the first component, the connecting piece having an at least approximately flat end face (14) and an inner opening,
the inner opening of the connecting piece being in connection with an oil-containing chamber of the first component and being at least partially provided with a thread (30),
a hollow connecting piece attached or attachable to the second component, the connecting piece having an end face adapted to the end face of the connecting piece of the first component and having an inner opening,
the inner opening of the second connecting piece being in connection with an oil-containing chamber of the second component and being at least partially provided with a thread,
whereby the pitch of the thread of both connecting pieces is different from each other, and comprising
a hollow screw that
has a thread corresponding to the thread of the first connecting piece followed by a thread corresponding to the thread of the second connecting piece.

2. Connection arrangement according to claim 1 comprising a device for the keyed lock against rotation of both connecting pieces about the axis formed by the axis of the screw.

3. Connection arrangement according to claim 2, wherein the device for locking the rotation of the two connecting pieces has at least one blind hole in the end face of each connecting piece and at least one alignment pin insertable in the blind hole and projecting beyond the end face.

4. Connection arrangement according to claim 1, whereby at least one end face has a groove running around the inner opening for receiving a seal.

5. Connection arrangement according to claim 1, whereby a connecting piece is welded to the housing of one component.

6. Connection arrangement according to claim 1, whereby at least one connecting piece is attached to a receiving ring that can be connected liquid-tight to the housing of the associated component.

7. Connection arrangement according to claim 6, whereby the receiving ring has a recess such as a groove and in particular a peripheral groove on its inside that is in connection with the inner opening of the connecting piece attached thereto and has a surface surrounding this recess, which surface is smooth.

8. Connection arrangement according to claim 7, whereby the housing of a component has at least one radial opening that ends in the recess of the receiving ring when the receiving ring is attached.

9. Connection arrangement according to claim 6, whereby the housing of a component has a recess such as a groove, in particular a peripheral groove, in its outer side facing the receiving ring, which recess is connected via a hole with the inner chamber of the component.

10. Connection arrangement according to claim 8, whereby to either side of the radial opening, the component has a peripheral groove opposite the smooth surface of the receiving ring to receive a seal.

11. Connection arrangement according to claim 1, whereby the hollow screw has a hexagon socket as a drive.

12. Connection arrangement according to claim 1, whereby the first component is a shock absorber, and the second component is an equalizing chamber for the shock absorber.
